(19) United States
(12) Patent Application Publication
(10) Pub. No.: US 2006/0246743 A1
(43) Pub. Date: Nov. 2, 2006

(54) Assembly for coupling to an electrical component

(75) Inventors: Ruth L. Llanos, Weston, FL (US); Aaron R. Allen, Pembroke Pines, FL (US); Douglas W. Moskowitz, Weston, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/118,709

(22) Filed: Apr. 29, 2005

(51) Int. Cl. H01R 41/00

(52) U.S. Cl. 439/32

(57) ABSTRACT

An assembly (200-400) has a portion of a housing (400), a connector (300), and a tray (200). The connector has one or more electrical contacts (302) for connecting to a corresponding electrical component (500). The tray is coupled to a surface (402) of the portion of the housing, wherein the tray slideably engages with the connector and the electrical component (FIGS. 7 and 10), thereby providing electrical contact between the connector and the electrical component.

### FIELD OF THE INVENTION

This invention relates generally to assemblies, and more particularly to an assembly for coupling to an electrical component.

### BACKGROUND OF THE INVENTION

An important design aspect of portable devices is the ability to maintain functional operation after experiencing stresses from a physical drop (e.g., 3 feet above ground). Assemblies in a portable device carrying an electrical component often lose electrical connectivity to the component after a drop condition, thereby interrupting operation of the portable device. Existing arrangements for carrying an electrical component fail to securely maintain connectivity after one or more drop conditions.

### SUMMARY OF THE INVENTION

Embodiments in accordance with the invention provide an assembly for coupling to an electrical component.

In a first embodiment of the present invention, an assembly has a portion of a housing, a connector and a tray. The connector has one or more electrical contacts for connecting to a corresponding electrical component. The tray is coupled to a surface of the portion of the housing, wherein the tray slideably engages with the connector and the electrical component, thereby providing electrical contact between the connector and the electrical component.

In a second embodiment of the present invention, a selective call radio (SCR) has a housing, an assembly, a communications component, and a processor coupled to the communications component, and the assembly for controlling operations thereof. The assembly can include a portion of the housing, a connector and a tray. The connector has one or more electrical contacts for connecting to a corresponding electrical component. The tray is coupled to a surface of the portion of the housing, wherein the tray slideably engages with the connector and the electrical component, thereby providing electrical contact between the connector and the electrical component.

In a third embodiment of the present invention, an assembly has a portion of a housing, a connector and a tray. The connector has one or more electrical contacts for connecting to a corresponding electrical component. The tray has a receptacle. The receptacle has one or more raised rims, and a portion without a raised rim. The receptacle further has an opening coupled to a plurality of raised protrusions. The one or more raised rims are coupled to a surface of the portion of the housing with a portion of said surface extending below the receptacle. The connector slideably engages with the plurality of raised protrusions with the one or more electrical contacts of said connector exposed by the opening, and the electrical component slideably engages through the section without the raised rim, thereby coupling to the one or more electrical contacts of the connector.

### BRIEF DESCRIPTION OF THE DRAWINGS

FIG. 1 is a block diagram of a selective call radio (SCR) in accordance with an embodiment of the present invention.

FIGS. 2-11 are illustrations of an assembly of the SCR for engaging with an electrical component in accordance with an embodiment of the present invention.

### DETAILED DESCRIPTION OF THE DRAWINGS

While the specification concludes with claims defining the features of embodiments of the invention that are regarded as novel, it is believed that the embodiments of the invention will be better understood from a consideration of the following description in conjunction with the figures, in which like reference numerals are carried forward.

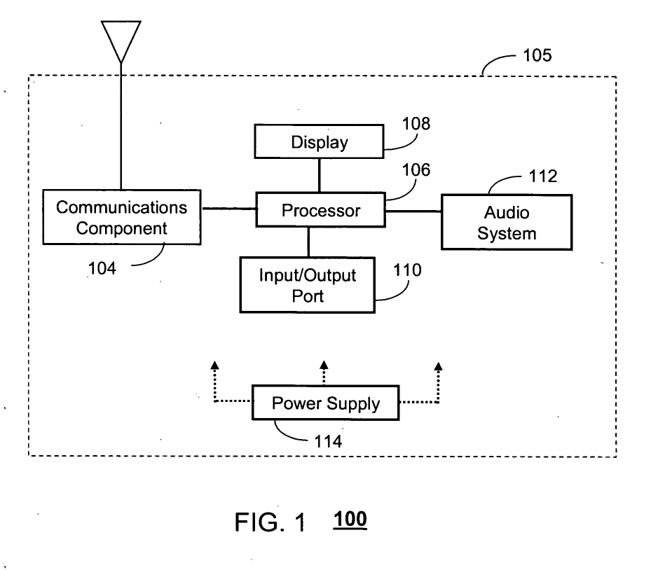

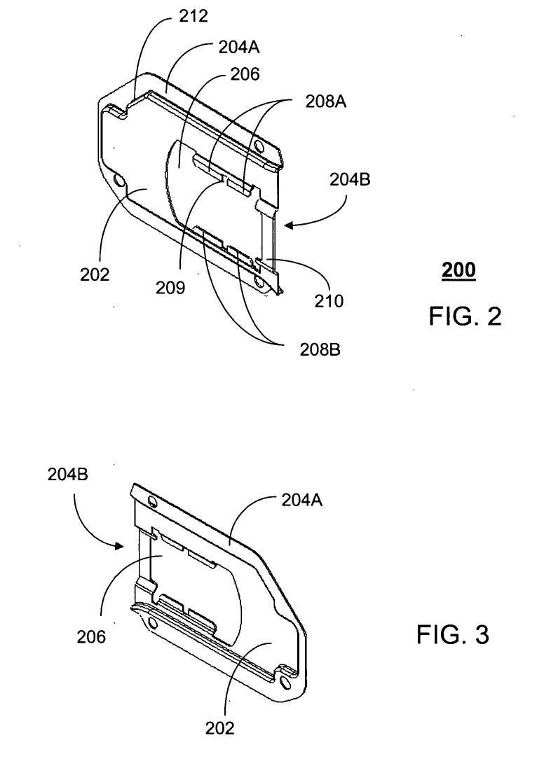

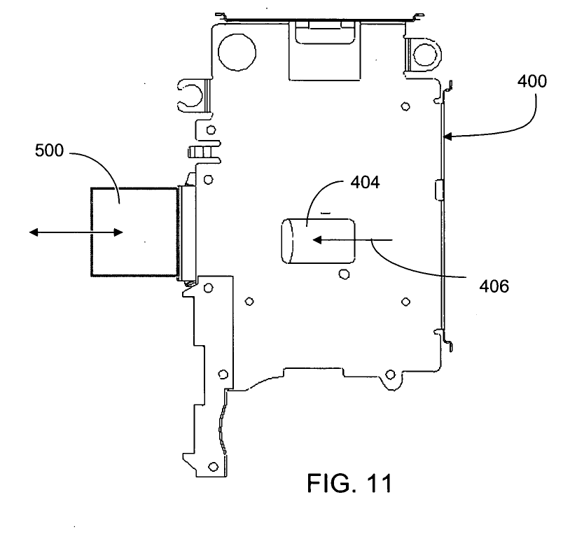

FIG. 1 is a block diagram of an SCR 100 in accordance with an embodiment of the present invention. The SCR 100 comprises conventional components such as a housing 105 for carrying the components of the SCR 100, a communications component 104, and a processor 106 coupled thereto to control operations of the SCR 100. The SCR 100 can further include conventional components such as a display 108 for displaying a UI (User Interface) and/or graphics to an end user of the SCR 100, an input/output port 110 for coupling to a keypad for directing functions of the processor 102 and an assembly 200-400 for receiving a SIN (Subscriber Identity Module) card 500 as will be shown in FIGS. 2-11, an audio system 112 for presenting audible signals such as music and alerts to the end user of the SCR 100, and a power supply 114 for supplying power to the components of the SCR 100.

The processor 106 utilizes conventional means such as a microprocessor, memory and software applications operating therein for controlling operations of the foregoing components 102-114 of the SCR 100. The communications component 104 can be a conventional wireless receiver or transceiver for processing messages of a conventional communication network such as a cellular phone network.

The foregoing electrical components 102-114 of the SCR 100 are carried in the housing using conventional materials such as plastics, metal, and/or other commonly used compounds. The housing includes an assembly 200-400 as shown in FIGS. 2-11 in accordance with an embodiment of the present invention. The portions of the housing not shown in FIGS. 2-11 include, for example, conventional components used in most SCRs 100 such as a flip housing portion for carrying the display 108 and a base-housing portion that carries the other aforementioned components of the SCR 100. Rear housing elements (not shown) can also be included with the flip and base-housing portions. For example, the flip portion can include a second component of the display 108 for presenting, for example, caller ID information, clock and date, or other pertinent information to an end user of the SCR 100. The base-housing portion can further include a rear battery door for insertion and removal of a conventional battery coupled to the power supply 114, and for removing the SIM card 500 as will be explained shortly.

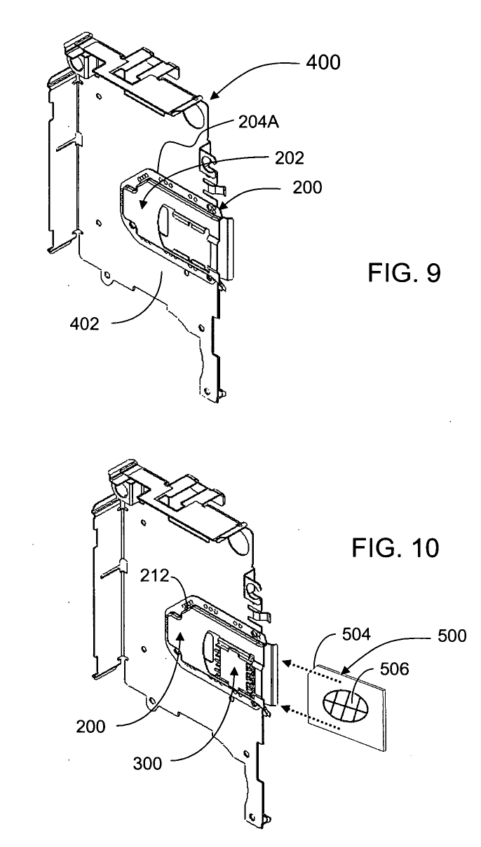

FIGS. 2-11 are illustrations of an assembly 200-400 of the SCR 100 for engaging with an electrical component (in this illustration, the SIM card 500) in accordance with an embodiment of the present invention. The assembly 200-400 comprises a surface 402 of a portion of a housing 400 (see FIGS. 9-11), a tray 200, and a connector 300 (hereinafter referred to as a SIM connector 300). In its simplest embodiment, the SIM connector 300 has one or more electrical contacts 302 for connecting to a corresponding electrical component such as a SIM card 500 shown in FIG. 10. It will be appreciated by an artisan with skill in the art that other electrical components suitable to the invention can be used (e.g., Flash memory card). The tray 200 is coupled to the surface 402 and slideably engages with the SIM connector 300 and the electrical component as shown in FIGS. 7 and 10, thereby providing electrical contact between the SIM connector 300 and the SIM card 500.

The surface 402 can be of any suitable material for coupling to the tray 200. In the present illustration, the surface 402 comprises a metallic surface 402, which is a portion of the housing of the SCR 100. In a supplemental embodiment, the tray 200 has a receptacle 202 with a raised rim 204A having in part a form-factor that at least substantially matches the form-factor of the SIM card 500 (see notch 212). A portion 204B of the tray 200 does not have a raised rim. This portion 204B allows engagement of the SIM card 500 with the tray 200 as will be shown.

The receptacle 202 further includes an opening 206 coupled to several raised protrusions 208A-B on both sides of the opening 206 that extend above said opening 206. The raised protrusions 208A-B have a gap 209, which as will be shown, can be used to prevent slideable movement with the SIM connector 300. In a supplemental embodiment, the tray 200 further comprises a raised projection 210 coupled to the opening for further limiting the slideable movement of the SIM connector 300. FIG. 3 shows a rear view of the tray 300.

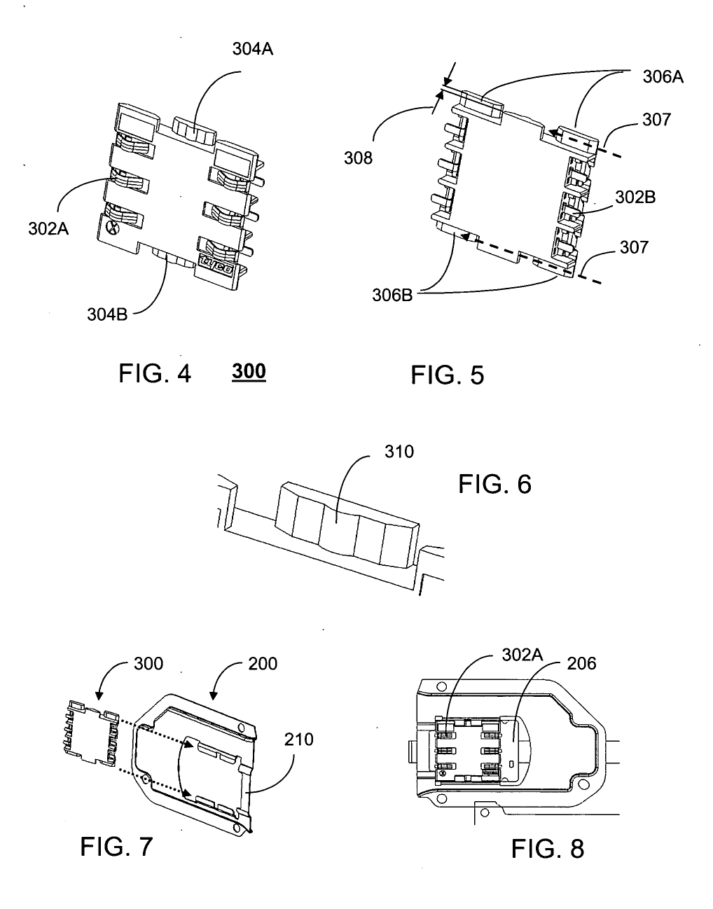

FIGS. 4-6 show front and rear views of the SIM connector 300 and a latching element 310 in accordance with an embodiment of the present invention. The SIM connector 300 has electrical contacts 302A-B on both the front and rear views. The contacts 302B of FIG. 5 can be coupled to a conventional flex connector (not shown), which in turn couples to the input port 110 of the SCR 100 by way of a corresponding connector on a PCB (Printed Circuit Board) carrying the components of the SCR 100. The contacts 302A of FIG. 4 are used for engaging to the electrical contacts 506 of the SIM card 500 (see FIG. 10).

The SIM connector 300 further has a first and second plurality of members 304A-B and 306A-B extending from surfaces of the SIM connector 300. The first and second plurality of members 304A-B and 306A-B have a separation 308 that forms a channel 307 therebetween sufficiently wide to slideably engage with the plurality of raised protrusions 208A-B shown in FIGS. 2 and 7. In addition, at least one of the first plurality of members 304A-B has a non-planar surface 310 for latching to the gap 209 of the plurality of raised protrusions 208, thereby securing the SIM connector 300 from further slidable movement. The raised projection 210 also limits the slideable movement of the SIM connector 300 for further alignment of the first plurality of members 304A-B and 306A-B with the raised protrusions 208A-B. FIG. 8 shows the exposed contacts 302A of the SIM connector 300 through the opening 206 once it is engaged with the tray 200.

FIGS. 9-10 show the final steps in the assembly 200-400. In FIG. 9, the raised rim 204A of the tray 200 is adhered to the metallic surface 402 with a portion of said surface extending below the receptacle 202. Alternatively, the raised rim 204A can extend below the receptacle 202 thereby providing a channel for slideable engagement with the electrical component. Adherence to the rim 204 can be performed by way of conventional solder or other suitable conventional adhering techniques. FIG. 10 shows the tray 200 coupled to the metallic surface 402 and with the SIM connector 300 engaged. From this point on, the SIM card 500 can slideably engage with the assembly 200-400 as shown. Like most conventional SIM cards, the SIM card 500 has a keyed corner 504 that aligns with notch 212 to ensure that the electrical contacts 506 of the SIM card 500 engage with the corresponding contacts of the SIM connector 300. Referring to FIGS. 9-11, to remove the SIM card 500 once it has engaged with the assembly 200-400, the surface 402 has an opening 404, which allows accessibility to the tray 200 and thus the SIM card 500 once it is fully engaged with the tray 200. The opening 404 provides for a slideable force 406 to be applied to the SIM card 500 for removal from the tray 200.

The multilayered assembly 200-400 provides for a sturdy electrical connection between the SIM connector 300 and the SIM card 500. The present invention can sustain substantial stresses imposed by a drop of the SCR 100 at varying heights without losing electrical contact between the SIM connector 300 and the SIM card 500.

In light of the foregoing description, it should be evident that embodiments in the present invention could be realized in numerous configurations contemplated to be within the scope and spirit of the claims below. It should also be understood that the claims are intended to cover the structures described herein as performing the recited function and not only structural equivalents. For example, although a nail and a screw fastener may not be structural equivalents in that the nail has no spiral threading, a nail and a screw fastener can be used for securing objects firmly together, thereby making the nail and screw fastener equivalent structures. Accordingly, equivalent structures that read on the description provided herein are intended to be included within the scope of the invention as defined in the following claims.

1. An assembly, comprising:
a portion of a housing;
a connector having one or more electrical contacts for connecting to a corresponding electrical component; and
a tray coupled to a surface of the portion of the housing, wherein the tray slideably engages with the connector and the tray slideably engages with the electrical component, thereby providing electrical contact between the connector and the electrical component.

2. The assembly of claim 1, wherein the tray comprises a receptacle,
wherein the receptacle has one or more raised rims, and a portion without a raised rim;
wherein the receptacle has an opening coupled to a plurality of raised protrusions;
wherein the one or more raised rims are coupled to the surface of the portion of the housing;
wherein the connector slideably engages with the plurality of raised protrusions with the one or more electrical contacts of said connector exposed by the opening; and
wherein the electrical component slideably engages through the portion without the raised rim, thereby coupling to the one or more electrical contacts of the connector.

3. The assembly of claim 2, wherein the one or more raised rims extend below the receptacle to provide a channel for slideable engagement with the electrical component.

4. The assembly of claim 2, wherein a portion of said surface extends below the receptacle to provide a channel for slideable engagement with the electrical component.

5. The assembly of claim 2, wherein the connector further comprises at least one latching element for engaging with one or more of the plurality of raised protrusions.

6. The assembly of claim 2, wherein the tray further comprises a raised projection coupled to the opening for limiting the slideable movement of the connector.

7. The assembly of claim 1, wherein the surface of the portion of the housing has at least one opening for applying a slideable force to remove the electrical component from the tray.

8. The assembly of claim 2, wherein a portion of the plurality of raised protrusions extends above the opening.

9. The assembly of claim 8, wherein the connector further comprises first and second plurality of members extending from surfaces of the connector, wherein the first and second plurality of members have a separation that forms a channel therebetween for slideably engaging with the plurality of raise protrusions.

10. The assembly of claim 9, wherein at least one of the first plurality of members has a non-planar surface for latching to the plurality of raised protrusions, thereby securing the connector from further slidable movement.

11. The assembly of claim 2, wherein the one or more of the raised rims are adhered to the surface of the portion of the housing.

12. A selective call radio (SCR), comprising:
a housing;
an assembly, comprising:
a portion of the housing;
a connector having one or more electrical contacts for connecting to a corresponding electrical component; and
a tray coupled to a surface of the portion of the housing, wherein the may slideably engages with the connector and the electrical component, thereby providing electrical contact between the connector and the electrical component; and
a communication component; and
a processor coupled to the communications component and the assembly for controlling operations thereof.

13. The SCR of claim 12, wherein the tray comprises a receptacle,
wherein the receptacle has one or more raised rims, and a portion without a raised rim;
wherein the receptacle has an opening coupled to a plurality of raised protrusions;
wherein the one or more raised rims are coupled to the surface of the portion of the housing;
wherein the connector slideably engages with the plurality of raised protrusions with the one or more electrical contacts of said connector exposed by the opening; and
wherein the electrical component slideably engages through the portion without the raised rim, thereby coupling to the one or more electrical contacts of the connector.

14. The SCR of claim 12, wherein the electrical component comprises a Subscriber Identity Module (SIM).

15. The SCR of claim 12, wherein the tray further comprises a raised projection coupled to this opening for limiting the slideable movement of the component.

16. The SCR of claim 12, wherein the surface of the portion of the housing has at least one opening for applying a slideable force to remove the electrical component from the tray.

17. The SCR of claim 13, wherein a portion of the plurality of raised protrusions of the tray above the opening, wherein the connector further comprises first and second plurality of members extending from surfaces of the connector, wherein the first and second plurality of members have a separation that forms a channel therebetween for slideably engaging with the plurality of raise protrusions, and wherein at least one of the first plurality of members has a non-planar surface for latching to the plurality of raised protrusions, thereby securing the connector from further slideable movement.

18. The SCR of claim 13, wherein the one or more of the raised rims are adhered to the surface.

19. The SCR of claim 12, further comprising at least one among a group of components comprising a display for conveying images to a user of the scr, and audio circuit for conveying audible signals to the user.

20. An assembly, comprising:
a portion of a housing;
a connector having one or more electrical contacts for connecting to a corresponding electrical component; and
a tray having a receptacle,
wherein the receptacle has one or more raised rims, and a portion without a raised rim;
wherein the receptacle has an opening coupled to a plurality of raised protrusions;
wherein the one or more raised rims are coupled to a surface of the portion of the housing with a portion of said surface extending below the receptacle;
wherein the connector slideably engages with the plurality of raised protrusions with the one or more electrical contacts of said connector exposed by the opening; and
wherein the electrical component slideably engages through the section without the raised rim thereby coupling to the one or more electrical contacts of the connector.
